(19) United States
(12) Patent Application Publication
(10) Pub. No.: US 2022/0130558 A1
(43) Pub. Date: Apr. 28, 2022

(54) MOLTEN METAL-FILLED SILICON CARBIDE FUEL CLADDING TUBE AND UNIFORM DISTRIBUTION FABRICATION METHOD

(71) Applicant: General Atomics, San Diego, CA (US)

(72) Inventors: Jiping Zhang, San Diego, CA (US); Jack Gazza, San Diego, CA (US); Gokul Vasudevamurthy, Knoxville, TN (US); Jonas Opperman, San Diego, CA (US); Arthur Blacklock, San Diego, CA (US); Austin Travis, Solana Beach, CA (US)

(21) Appl. No.: 17/079,328

(22) Filed: Oct. 23, 2020

(51) Int. Cl. G21C 3/07; G21C 3/10; G21C 21/00; G21C 3/22; G21C 3/58; G21C 3/04

(52) U.S. Cl. CPC G21C 3/07; G21C 3/10; G21C 3/045; G21C 3/22; G21C 3/58; G21C 21/00

(57) ABSTRACT

Fuel rod designs and techniques are provided to encapsulate nuclear fuel pellets in nuclear fuel rods. The tubular cladding in the disclosed fuel rods includes silicon carbide and a metal filler structure formed of a metal that becomes molten during a nuclear reaction of the nuclear fuel pellets and located inside the tubular cladding to include a metal tube that fills in a gap between the nuclear fuel pellets and an interior side wall of the tubular cladding and structured to include a closed metal end cap at one end of the nuclear fuel pellets to leave a space between one end of the interior of the tubular cladding and the closed metal end cap of the metal filler structure as a reservoir.

### TECHNICAL FIELD

This patent document relates to tubes for holding nuclear fuel materials such as fuel pellets.

### BACKGROUND

Many nuclear reactors use a fissile material as the fuel to generate power via nuclear fission chain reactions. The fuel is usually held in a robust physical container such as interior of fuel rods capable of enduring high operating temperatures and an intense neutron radiation environment. Fuel structures need to maintain their shape and integrity over a period (e.g., several years) within the reactor core, thereby preventing the leakage of fission products into the reactor coolant. Other structures, such as heat exchangers, nozzles, nosecones, flow channel inserts, or related components, also require high temperature performance, corrosion resistance, and specific, non-planar geometries where high dimensional accuracy is important.

### SUMMARY

This patent document discloses devices, systems, and methods for providing improved thermal conductivity and encapsulating nuclear fuel materials such as fuel pellets.

In one aspect, an apparatus is configured to encapsulate a stack of nuclear fuel pellets is disclosed. The apparatus includes a tubular cladding structured to have a hollow interior with a length, an inside cross-sectional shape, and an outside cross-sectional shape to hold nuclear fuel pellets inside the tubular cladding, wherein the tubular cladding includes silicon carbide; and a metal filler structure formed of a metal that becomes molten during a nuclear reaction of the nuclear fuel pellets and located inside the tubular cladding to include a metal tube that fills in a gap between the nuclear fuel pellets and an interior side wall of the tubular cladding and structured to include a closed metal end cap at one end of the nuclear fuel pellets to leave a space between one end of the interior of the tubular cladding and the closed metal end cap of the metal filler structure as a reservoir positioned between the end of the tubular cladding material and the closed metal end cap of the metal filler structure to accumulate a fission gas from the nuclear fuel pellets during a nuclear reaction of the nuclear pellets.

The following features can be included in various combinations. The cladding material is monolithic silicon carbide. The cladding material is CMC. The reservoir comprises a spring or a spacer. The inside cross-sectional shape and the outside cross-sectional shape are circular. The nuclear fuel pellets comprise U₃Si₂, UN, or UO₂. The continuous gap has a thickness between about 50 and about 150 □m. The metal can be tin (Sn). The tubular cladding and metal filler are configured to stop a coolant ingress into the tubular cladding from a micro-crack leak through the tubular cladding by formation of a metal oxide that fills the micro-crack with the metal oxide due to a chemical reaction of the metal filler structure with coolant at a location of the leak.

In another aspect, the disclosed technology can be implemented to provide a method for encapsulating nuclear fuel pellets inside a nuclear reactor. This method includes placing nuclear fuel pellets inside a hollow interior space within a tubular cladding structured to include SiC to hold the nuclear fuel pellets inside the tubular cladding with a contiguous gap between the nuclear fuel pellets and an interior sidewall of the tubular cladding and one interior end of the tubular cladding, and forming a metal filler structure formed of a metal that becomes molten during a nuclear reaction of the nuclear fuel pellets inside the tubular cladding and structured to include a metal tube that fills in the continuous gap between the nuclear fuel pellets and the interior side wall of the tubular cladding to provide sealing to interior of the tubular cladding during the nuclear reaction and structured to include a closed metal end cap at one end of the nuclear fuel pellets to leave a space between one end of the interior of the tubular cladding and the closed metal end cap of the metal filler structure as a reservoir for accumulating a fission gas from the nuclear fuel pellets during a nuclear reaction of the nuclear pellets.

The above and other aspects and their implementations are described in greater detail in the drawings, the description and the claims.

### BRIEF DESCRIPTION OF THE DRAWINGS

FIG. 1A shows an exemplary nuclear fuel assembly, in accordance with some example embodiments.

FIG. 1B depicts an example of tin backfilled silicon carbide (SiC) tube with one or more nuclear fuel pellets, in accordance with some example embodiments.

FIG. 2 depicts another example of tin backfilled SiC tube with a fuel pellet stack including one or more fuel pellets.

FIG. 3 shows x-ray computed tomography (XCT) images of SiC cladding with and without tin, in according to some example embodiments.

FIG. 4 shows some physical properties of Sn.

FIG. 5 shows 29 elements and their associated fission yield over various time periods.

FIG. 6 depicts a set-up for testing the quality of a tin backfilled cladding, in accordance with some example embodiments.

FIG. 7 shows an example of a 2-D x-ray scan of a SiC tube with molybdenum (Mo) pellets and tin bonding.

### DETAILED DESCRIPTION

The disclosed devices and techniques significantly improve the thermal conduction between nuclear fuel pellets and the cladding tube wall by filling silicon carbide nuclear fuel cladding tubes with molten metals such as molten tin. The use of other non-metals (carbon or silicon) may also be possible. However, the use of molten tin is unique to silicon carbide cladding, as molten tin will unfavorably corrode common metal claddings such as Zircaloy. The disclosed devices have uses in areas including nuclear reactor claddings, thermal storage and extraction components, heat recovery system components, nuclear waste treatment and storage.

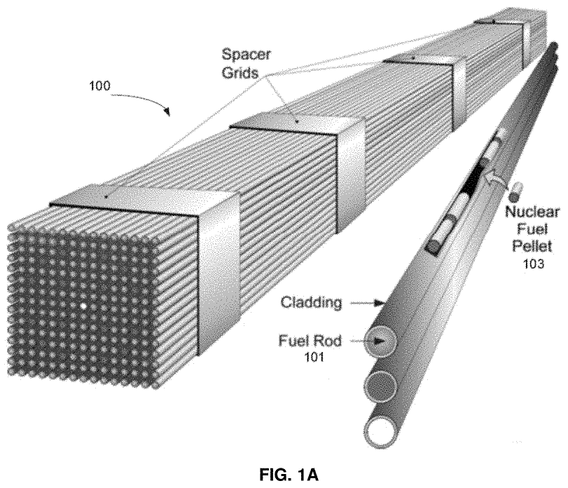

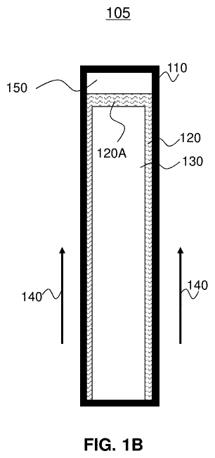

The nuclear fuel material used in a nuclear reactor is usually held in fuel rods capable of enduring high operating temperatures and an intense neutron radiation environment. Fuel structures need to maintain their shape and integrity over a long time period within the reactor core, thereby preventing the leakage of fission products into the reactor coolant of a reactor. FIG. 1A shows an example of a nuclear fuel rod assembly 100 formed of a bundle of fuel rods 101 used in a nuclear reactor. Each rod has a hollow interior to contain nuclear fuel pellets 103 such as Uranium-containing pellets and spacer grids are used to hold the rods in the assembly. A reactor is designed to hold many nuclear fuel rod assemblies in operation. Some fuel rods use zirconium cladding but the fuel rods in this document use SiC ceramic matrix composites (CMCs) for improved performance.

Silicon carbide (SiC) can be used in both fission and fusion applications, and recently has been considered as a candidate material for accident tolerant fuel cladding for light water reactors. High purity, crystalline SiC is a stable material under neutron irradiation, undergoing only minimal swelling and strength changes to 40 dpa and higher, which represents many times the exposure for a typical light water reactor (LWR) fuel life. In addition, SiC retains its mechanical properties at high temperature and reacts slowly with steam compared to Zircaloy, thus affording improved safety for water cooled reactors in a loss-of-coolant (LOCA) and other potential accident conditions. However, various monolithic SiC materials alone tend to exhibit low fracture toughness and such materials are unsuitable for nuclear cladding applications where fuel containment is essential and a coolable geometry must be maintained, especially under transient or off-normal conditions. Engineered composite structures can be used to address this brittle behavior of such monolithic SiC materials, using strong silicon carbide fibers that reinforce a SiC matrix to form a SiC—SiC composite. Compared to monolithic SiC, these composites offer improved fracture toughness, pseudo ductility, and undergo a more graceful failure process. High purity, radiation tolerant silicon carbide composites are typically fabricated using chemical vapor infiltration (CVI). While CVI provides the necessary purity for nuclear applications, it is challenging to reach very low porosity levels (<5%). As a consequence, the composite alone may not be sufficient to contain one or more fission gases within the fuel cladding. Ultimately, a SiC-based cladding structure that is optimized to combine a tough SiC—SiC composite with a monolithic SiC layer, where the dense, monolithic SiC serves as an impermeable fission gas barrier and provides improved corrosion resistance, is the most promising design to achieve a completely SiC-based accident tolerant fuel cladding design. Moreover, added protection can be achieved using the disclosed technique of using tin as a molten gap filler between the cladding and fuel pellets.

In various nuclear reactor applications, in addition to providing desired strength or toughness at high temperatures caused by nuclear reactions, it is desirable that SiC-based fuel cladding meet a range of material property requirements and performance requirements, exhibit stability under irradiation, and have reduced oxidation compared to other nuclear cladding materials such as zircaloy. These requirements are primarily driven by differences between properties of silicon carbide structures compared to Zircaloy tubes, and the resulting implications of these differences on the performance. Specifically, the properties of SiC-based cladding are highly dependent on the processing route used, particularly for any fiber reinforced composite layers. In addition, while SiC—SiC composites undergo pseudo-ductile fracture rather than brittle failure, extensive micro-cracking occurs during this process which can lead to a loss of hermeticity. This micro-cracking occurs at strains in the range of 0.1% a strain level at which Zircaloy cladding would not yet exhibit any plastic deformation. Accordingly, attention to characterization and careful development of the SiC-based cladding design is needed to mitigate micro-cracking and ensure hermeticity. Another consideration is that while silicon carbide has a lower irradiated thermal conductivity than Zircaloy, it does have the advantage of not undergoing irradiation-induced creep at LWR operating temperatures like Zircaloy, which will delay pellet-cladding mechanical interactions and associated stresses.

Achieving controllable cladding tube circularity, roughness, and straightness therefore are very important for predictable heat transfer through the cladding. The lower thermal conductivity of a SiC-based cladding leads to higher temperature gradients through the cladding for a given linear heat rate. These temperature gradients can lead to significant stresses due to thermal expansion and irradiation-induced, temperature-dependent swelling. These stresses (and corresponding failure probabilities) can be reduced by decreasing the cladding wall thickness, which in turn lowers the temperature gradient. In addition, the cladding architecture (a combination of composite and monolithic SiC layers) can significantly influence the stress distribution though the cladding thickness during normal operating conditions as well as accident scenarios. With careful design, the stresses on critical layers within the cladding structure can be reduced. However, there are fabrication and handling challenges associated with both reductions in the wall thickness for long fuel cladding tubes, and production of specially designed tube structures.

The implementation of SiC-based accident tolerant cladding tubes in light water reactors will not only require design of optimized structures and development of consistent, scalable fabrication methods, this will also require thorough understanding and characterization of the material being produced. Among other performance metrics, the mechanical and thermal properties must be measured, and the permeability must be assessed. A limited collection of test standards has been accepted by the community (ASTM C28.07 ceramic matrix composite sub-group), and development of additional characterization tools is necessary.

The PCT Application Nos. PCT/US2018/055704 entitled “JOINING AND SEALING PRESSURIZED CERAMIC STRUCTURES,” filed 12 Oct. 2018 and PCT/US2017/045990 entitled “ENGINEERED SIC-SIC COMPOSITE AND MONOLITHIC SIC LAYERED STRUCTURES,” filed 8 Aug. 2017 include technical information related to the disclosed technology in this patent document are incorporated by reference as part of the disclosure of this patent document in their entirety.

Currently, LWR cladding contains high pressure helium to provide heat transfer between the nuclear fuel and the cladding. The thermal conduction of the high pressure helium surrounding the fuel pellets is much lower than a liquid metal such as tin (Sn). The disclosed tin filled SiC cladding tubes provide about a 200-fold improvement in the thermal conductivity between the fuel and the cladding. The higher efficiency of the disclosed techniques reduces the fuel temperature by about 500 C which provides a greater margin for accident prevention. The higher efficiency also increases the fuel utilization and reduces waste. Tin filled SiC cladding tubes have the advantage of mitigating microcracks in the SiC cladding, which limits coolant ingress into the cladding and fuel interaction with leaked coolant by forming tin-oxides. With sufficient molten tin available after a leak, the tin provides for self-healing of the SiC cladding by backfilling the location of the leak.

The normal operational cladding temperature of a light water reactor (LWR) is about 343 C. This operating temperature makes tin or a tin eutectic a suitable molten metal because tin has a melting point of 232 C and thus is in the liquid phase at the LWR operating temperature.

The tin filled SiC cladding also makes fabrication easier and reduces cost by eliminating pressure sealing, spring components, and post fabrication smoothing of the inner surface of the cladding. A smooth inner surface is desirable for the safe loading of fuel pellets. The cladding tube containing fuel pellets backfilled with tin secures the fuel pellets making transportation before (pre-irradiation) use safer. Post irradiation benefits include quicker cooling of the fuel rods than He-filled fuel rods due to the increased thermal conductivity of the tin backfilled rods. For example, experimental results of the disclosed devices have shown an improvement in the thermal conductivity of tin filled fuel rods to about 60 Watts per meter Kelvin (W/m K) compared to about 0.2 W/m K for Helium.

In addition to tin, various other metals with low melting points can be used to implement the disclosed technology. For example, metals such as lead (Pb) or bismuth (Bi) and others located near Sn in the periodic table may be used. In various fuel rodlet designs for reactor applications, tin has another property in the event of a rodlet leak, tin has the added benefit that tin can react with water to form a stable tin oxide SnO₂ that is insoluble in water and can be used to stop the leaking. The liquid metal (e.g., Sn) backfill enhances the water impermeability of SiC ceramic matrix composite (CMC) tube by providing an internal seal against water ingress. If the cladding develops a small hole that starts to leak coolant or water through the SiC cladding, the Sn reacts with the coolant/water to form a tin oxide at the location of the leak. The tin oxide has a melting point that is >1600 C which is higher than the temperature of the tin or cladding. The tin oxide effectively self-heals or fills the leak which protects the uranium silicide pellets coming into contact with the coolant. Using the disclosed tin backfill eliminates the need for high pressure He backfill which simplifies the process of sealing. The Sn backfill also stabilizes pellets during transportation and storage.

Advantages of the disclosed Sn backfill include: Sn is a better thermal conductor than He, the fuel rod including the fuel pellets and Sn backfill has no initial internal pressure (unlike the current high pressure He backfill), sealing the ends of the cladding tubes is easier than when He is used, in operation the Sn backfill reduces the probability of a gas leak, leaks will heal due to quick oxidation of Sn, the Sn backfilled cladding tubes have a simpler internal structure than conventional high-pressure He backfilled tubes since high-pressure gas seals are not needed, no spring needed in the Sn backfilled tubes, fuel pellets loading is improved, the molten Sn serves as a lubricant in the operational system, and ease for transportation since Sn is a solid at transportation temperatures and the pellets will be protected.

FIG. 1B depicts an example 105 of tin backfilled SiC tube with fuel pellets 130, in accordance with some example embodiments. The fuel tube 105 includes a tubular cladding 110 made from silicon carbide (SiC) ceramic matrix composite (CMC), monolithic SiC, other material including SiC, or other high temperature ceramic or material. The interior space inside the tubular cladding 110 is filled with nuclear fuel pellets 130 and the volume ore size of the fuel pellets 130 is smaller than the interior size of the tubular cladding 110 to form a gap of about 50 μm to 150 μm between the interior side wall of the tubular cladding 110. The gap between the fuel pellets 130 and the inside of the tubular cladding 110 is filled with a suitable metal filler structure 120 such as tin (Sn) to provide a sealing interface on the interior wall of the tubular cladding 110, to fill in cracks in the tubular cladding 110 and to provide bonding between the fuel pallets 130 from the SiC tubular cladding. The metal filler structure 120 forms a tubular structure as illustrated to include a close tubular end 120A on the top of the nuclear fuel pellets 130 and is spaced from the top interior end of the tubular cladding 110 to enclose an interior space as a reservoir 150 which allows for accumulation of fission gasses during operation. The reservoir 150 includes an open volume for the gasses and may include springs and/or spacers such as SiC spacers. Fission gasses from the fuel pellets diffuse through the molten tin and accumulate in the reservoir 150 until the cladding tube internal pressure equilibrates. When fission gases accumulate in the liquid tin and form gas bubble, the gas bubble will float up to the reservoir.

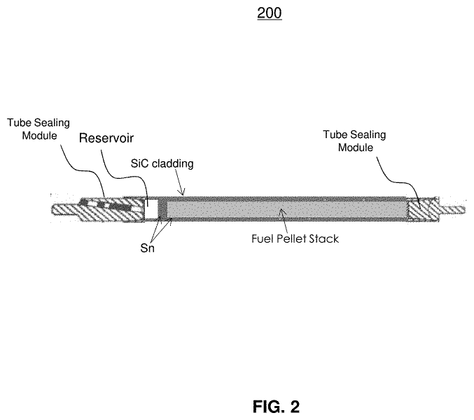

FIG. 2 depicts another example 200 of tin backfilled SiC tube with fuel pellets. The external layer is SiC cladding and the two ends of the tube are sealed by two sealing modules with an interior reservoir formed internally at one side on the left. Inside the cladding is a fuel pellet stack with tin (Sn) bonding the fuel pellet stack to the SiC cladding at temperatures below the melting point of Sn (232C). The encapsulated fuel pellet stack is mechanically stable and supported by the SiC cladding and Sn bonding.

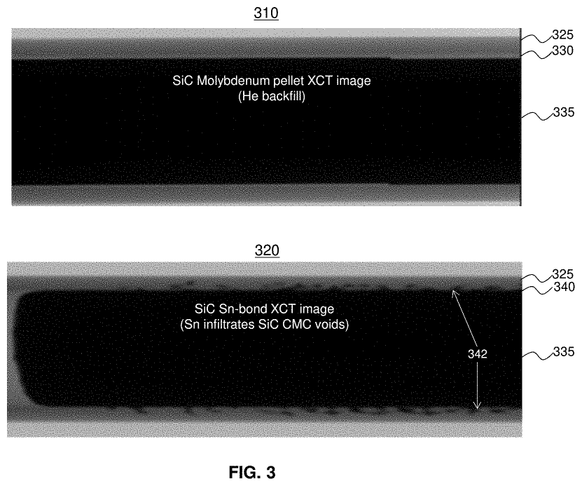

FIG. 3 shows x-ray computed tomography (XCT) images of SiC CMC cladding with and without Sn, in according to some example embodiments. The image at 310 shows an XCT image showing SiC cladding 325 and a molybdenum (Mo) fuel pellet 335 with the cladding backfilled with He 330 without Sn. The image at 320 shows an XCT image showing SiC CMC cladding 325 and a molybdenum (Mo) fuel pellet 335 with the cladding backfilled with Sn 340 without He. Example locations where Sn fills voids in the SiC CMC cladding are shown at 342. By the Sn filling the voids in the SiC CMC, the thermal conductivity is enhanced and if there is a micro-crack leak through the SiC cladding, water ingress is stopped by the formation of Sn oxide that fills the microcrack due to reaction of the Sn with the coolant at the leak location. Note that 342 only identifies two locations where Sn sills the voids but there are many others along the length of the cladding in the image.

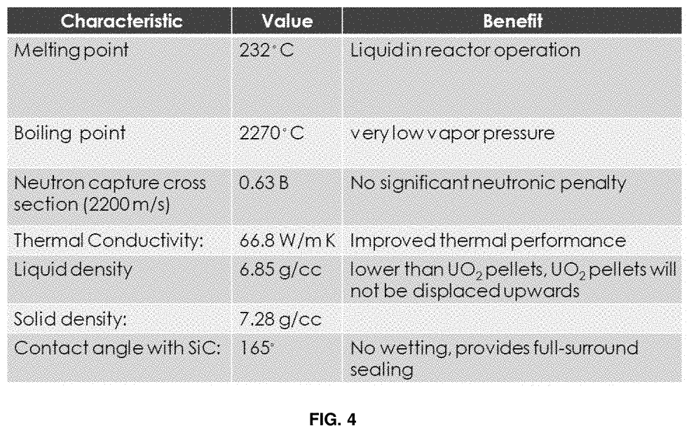

FIG. 4 shows some properties of Sn. The melting point and boiling point of Sn is compatible with LWRs.

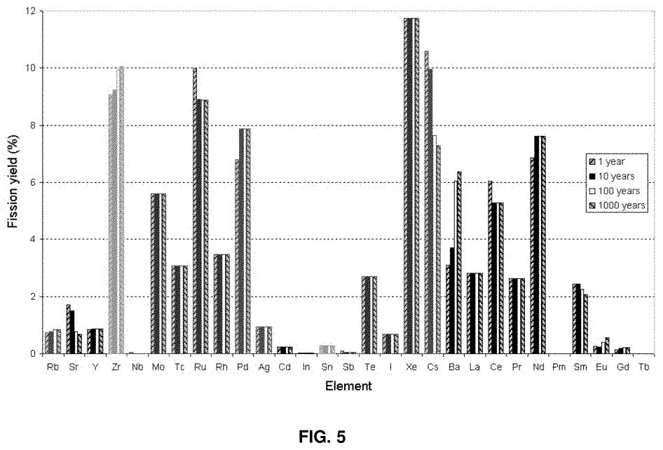

FIG. 5 shows 29 elements and their associated fission yield over various time periods including 1 year, 10, years, 100 years, and 1000 years. An element that has a low fission yield is a stable element to use in a LWR. Sn has a very low fission yield making it a good candidate for backfilling nuclear fuel pellet tubes.

In an implementation, molybdenum (Mo) pellets were used and the molten metal fully filled the gap between the fuel pellets and the inside surface of a monolithic SiC cladding tube.

Based on an enthalpy (H), entropy (S) and heat capacity (C), of HSC simulation, no liquid tin induced corrosion/reaction or corrosion of SiC cladding tube occurs. HSC simulations confirm that no liquid tin induced corrosion/reaction occurs with uranium dioxide (UO₂) at least up to 1500 C. HSC simulations confirm that no liquid tin induced corrosion/reaction occurs with U₃Si₂ up to at least 1500 C making tin compatible with U₃Si₂ fuel.

Most of the fission products will not chemically react with Sn. Iodine (I) will react with Sn according to the reaction: Sn+I₂ (g)=SnI₂ but since there is large amount of cesium (Cs) in the fission gas, CsI is formed rather than SnI₂. As such, I is compatible with the disclosed techniques.

As described above, a reservoir including open space above the fuel stack accumulates fission gasses. Fission gases will diffuse up through the Sn via a pressure gradient until equilibrium is reached. The fission gases do not significantly impact thermal conduction.

There are several paths for the generation of xenon-135 (¹³⁵Xe). In a first path, a neutron is captured by ¹³⁵Xe becoming stable ¹³⁶Xe with high cross section of 2.65E6 Barn. In a second path, beta decay into ¹³⁵Cs with half-life of 9.17 hours. If the fuel tube is filled with He, the first path dominates. If tube filled with liquid tin, ¹³⁵Xe will bubble up to the top at the reservoir giving the ¹³⁵Xe less of an opportunity to capture a neutron, the second dominates. Neutron control will be different. Using tin, it is possible avoid ¹³⁵Xe caused low neutron density issues.

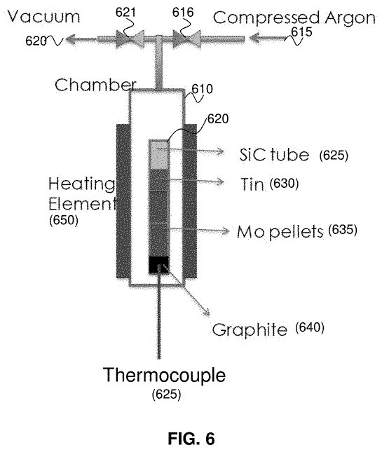

FIG. 6 depicts a set-up for testing the quality of a tin backfilled cladding, in accordance with some example embodiments. Chamber 610 is surrounded by heating elements 650. Valves 616 and 621 control a vacuum 620 connected to the chamber or compressed argon 615 connected to the chamber. Inside the chamber 610 is SiC tuber 625 and inside tube 625 are Mo pellets 635 and Sn 630. Graphite 640 is at the bottom of SiC tube 625. Thermocouple 645 measures the temperature inside the SiC tube 625.

The following steps are performed to make a SiC cladding tube with Mo fuel pellet with Sn bonding. In a first step, a vacuum is pulled on the chamber 610 by opening value 621 and closing valve 616. Next, heating elements 650 heat the chamber and contents to >350 C to allow Sn to melt. Next, the chamber is pressurized to push liquid tin into the gap between the Mo fuel pellets and inside wall of the SiC tube.

Inspection includes inspecting the Sn oxidation involving adjusting the vacuum level, adding H₂ to Ar as an O₂ getter, and inspecting the Sn quality. Inspection also includes inspecting the Sn backfill uniformity.

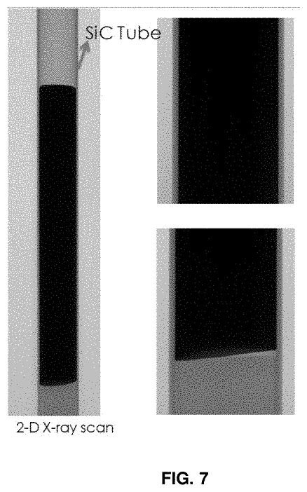

FIG. 7 shows an example of a 2-D x-ray scan of a SiC tube with Mo pellets and Sn bonding. In the example of FIG. 7, the tube is monolithic SiC with an inside diameter of 8.20 mm. There are five Mo pellets each with a diameter of 7.76 mm. The vacuum pulled using the set-up of FIG. 6 was 60 mTorr, and 80 psi N₂ was used, the temperature at the thermocouple was 500 C (bottom), and the duration before pressure was 30 minutes, and the pressure duration was until the thermocouple read room temperature. Th-D x-ray scan indicates that the gap is filled with Sn with a gap uniformity of 25 micrometers.

In some example embodiments, a SiC tube with fuel pellets and metal bonding can be fabricated using the following fabrication steps: 1) Load fuel pellets into one end of a sealed cladding tube with tin particles or strips between the pellets and cladding tube inner diameter; 2) Add more tin above pellets in the fission gas reservoir area so that total volume of tin is equal to total gap volume; 3) Put the tube in vacuum/pressure chamber and pump the cladding tube to vacuum level of around 10 mTorr; 4) Heat the tube to a temperature above the tin melting point (230C) so that both the tin in the gap and on top will be melted; 5) Stop vacuum pumping and apply argon pressure from top to push liquid tin down to fill the gap; and 6) Cool down and let the tin solidify. In some example embodiments, the pellets are Mo pellets and the metal is tin.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various components in the embodiments described in this patent document should not be understood as requiring such separation in all embodiments.

Only a few implementations and examples are described, and other implementations enhancements and variations can be made based on what is described and illustrated in this patent document.

What is claimed is:

1. An apparatus configured to encapsulate nuclear fuel pellets, comprising:
a tubular cladding structured to have a hollow interior with a length, an inside cross-sectional shape, and an outside cross-sectional shape to hold nuclear fuel pellets inside the tubular cladding, wherein the tubular cladding includes silicon carbide; and
a metal filler structure formed of a metal that becomes molten during a nuclear reaction of the nuclear fuel pellets, the metal filler structure located inside the tubular cladding to include a metal tube that fills in a gap between the nuclear fuel pellets and an interior side wall of the tubular cladding and structured to include a closed metal end cap at one end of the nuclear fuel pellets to leave a space between one end of the interior of the tubular cladding and the closed metal end cap of the metal filler structure as a reservoir positioned between the end of the tubular cladding and the closed metal end cap of the metal filler structure to accumulate a fission gas from the nuclear fuel pellets during a nuclear reaction of the nuclear pellets.

2. The apparatus of claim 1, wherein the tubular cladding and metal filler are configured to stop a coolant ingress into the tubular cladding from a micro-crack leak through the tubular cladding by formation of a metal oxide that fills the micro-crack with the metal oxide due to a chemical reaction of the metal filler structure with coolant at a location of the leak.

3. The apparatus of claim 1, wherein the tubular cladding includes monolithic silicon carbide.

4. The apparatus of claim 1, wherein the tubular cladding includes one or more silicon carbide ceramic matrix composites.

5. The apparatus of claim 1, further comprising a spring or a spacer located inside the reservoir.

6. The apparatus of claim 1, wherein the tubular cladding and the metal filler structure are configured to be suitable to contain the nuclear fuel pellets that comprise: U₃Si₂, UN, or UO₂.

7. The apparatus of claim 1, wherein the metal filler structure is structured so that the gap filled in by the metal filler structure has a thickness of between about 50 μm and about 150 μm.

8. The apparatus of claim 1, wherein the metal for forming the metal filler structure includes tin (Sn).

9. The apparatus of claim 1, wherein the metal for forming the metal filler structure includes a metal that is different from tin (Sn).

10. The apparatus of claim 1, wherein the metal for forming the metal filler structure includes lead (Pb).

11. The apparatus of claim 1, wherein the metal for forming the metal filler structure includes bismuth (Bi).

12. The apparatus of claim 1, wherein the metal for forming the metal filler structure includes a metal located near Sn in the periodic table.

13. A method for encapsulating nuclear fuel pellets, comprising:
placing nuclear fuel pellets inside a hollow interior space within a tubular cladding structured to include SiC to hold the nuclear fuel pellets inside the tubular cladding with a continuous gap between the nuclear fuel pellets and an interior sidewall of the tubular cladding and one interior end of the tubular cladding; and
forming a metal filler structure that becomes molten during a nuclear reaction of the nuclear fuel pellets inside the tubular cladding and structured to include a metal tube that fills in the continuous gap between the nuclear fuel pellets and the interior sidewall of the tubular cladding to provide sealing to interior of the tubular cladding during the nuclear reaction and structured to include a closed metal end cap at one end of the nuclear fuel pellets to leave a space between one end of the interior sidewall of the tubular cladding and the closed metal end cap of the metal filler structure as a reservoir for accumulating a fission gas from the nuclear fuel pellets during a nuclear reaction of the nuclear fuel pellets.

14. The method of claim 13, wherein when a micro-crack leak through the silicon carbide cladding occurs, water ingress is stopped by formation of metal oxide that fills the micro-crack due to a chemical reaction of the metal filler structure with a coolant at a location of the leak.

15. The method of claim 13, wherein the tubular cladding includes monolithic silicon carbide.

16. The method of claim 13, wherein the tubular cladding includes one or more silicon carbide ceramic matrix composites.

17. The method of claim 13, wherein the metal filler structure includes tin (Sn).

18. The method of claim 13, wherein the metal filler structure includes a metal located near tin (Sn) in the periodic table.

19. The method of claim 13, wherein the nuclear fuel pellets that comprise: U₃Si₂, UN, or UO₂.

20. The method of claim 13, wherein the metal filler structure has a thickness of between about 50 μm and about 150 μm.
